(19) United States
(12) Patent Application Publication
(10) Pub. No.: US 2010/0064247 A1
(43) Pub. Date: Mar. 11, 2010

(54) Accordion Control For User Selectable Fastpath

(75) Inventors: Jack Allen Alford, JR., Austin, TX (US); Kelly Lorraine Lisai, Austin, TX (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(73) Assignee: International Business Machines Corporation, Armonk, NY (US)

(21) Appl. No.: 12/205,948

(22) Filed: Sep. 8, 2008

(51) Int. Cl. G06F 3/048

(52) U.S. Cl. 715/781

(57) ABSTRACT

A method, programmed medium and system are provided for enabling a user to choose a degree to which displayed input panes are opened for user input. Initially, an information record is segmented into input panes by type of content, and different types of content are presented in separately displayed information input panes on a display screen. Icon buttons are implemented in one exemplary embodiment to enable the user to control the degree to which the separately displayed panes are opened for information input. In one exemplary embodiment, there is described a partially open state, i.e. one in which only one or two critical interaction elements are visible in the display screen. For example, a partially open state may include only a single text entry field with its accompanying label. This state corresponds to the “fast path” or expert mode in current applications. Additional help completing the text field or other control may be accessed by the user selection of a control icon in the accordion pane header to open the pane fully to include additional input fields and/or explanatory text.

### FIELD OF THE INVENTION

The present invention relates generally to information processing systems and more particularly to a methodology and implementation for enabling more efficient user data input to computerized records.

### BACKGROUND OF THE INVENTION

Graphical user interface designers must often design alternative user interfaces for “novice” and “expert” users. The “novice” interface might be implemented as a “wizard”, with multiple small steps on separate pages, accompanied by a relatively large amount of explanatory text. The novice system provides a great deal of explanatory information but a large amount of scrolling is required to reach the end of the input record. The “expert” or “fast-path” interface is more direct, with multiple data entry fields and other user interaction controls on the same page, and much less text. It is important for software products to try to meet the needs of different types of users, but the resulting duplication of function in the user interface adds programming and maintenance workload, and may confuse users, who are confronted with multiple paths to perform the same action. If the developer attempts to avoid the multiple-interface problem by providing only a wizard or fast-path interface, then one group of users must cope with a non-optimal user interface.

Thus, there is a need to provide a data input system which is effective to enable users to quickly enter data to computerized records with only minimal scrolling.

### SUMMARY OF THE INVENTION

A method, programmed medium and system are provided for enabling a user to choose a degree to which displayed input panes are opened for user input. Initially, an information record is segmented into input panes by type of content, and different types of content are presented in separately displayed information input panes on a display screen. Icon buttons are implemented in one exemplary embodiment to enable the user to control the degree to which the separately displayed panes are opened for information input. In one exemplary embodiment, there is described a partially open state, i.e. one in which only one or two critical interaction elements are visible in the display screen. For example, a partially open state may include only a single text entry field with its accompanying label. This state corresponds to the “fast path” or expert mode in current applications. Additional help completing the text field or other user interface controls may be accessed by the user selection of a control icon in the accordion pane header to open the pane fully to include additional input fields and/or explanatory text.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of one embodiment of a system in which the present invention may be implemented;

FIG. 2 is a block diagram showing several of the major components of an exemplary system using the present invention;

FIG. 3 is an illustration of a screen display showing an input record having several information input panes;

FIG. 4 is an illustration of a screen display showing an input record having several information input panes in which one of the input panes has been opened to a partially open state to display additional features for input selection;

FIG. 5 is an illustration of a screen display showing an input record having several information input panes in which two of the input panes have been opened to a partially open states; and

FIG. 6 is a flow chart illustrating an exemplary sequence of operations which may be implemented in accordance with the present invention.

### DETAILED DESCRIPTION

The various methods discussed herein may be implemented within a computer system which includes processing means, memory, storage means, input means and display means. Since the individual components of a computer system which may be used to implement the functions used in practicing the present invention are generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention. Although the invention is illustrated in the context of a networked computer system using a laptop computer, it is understood that disclosed methodology may also be applied in many other available and future devices and systems such as cell phones and personal wireless and other hand-held devices, to achieve the beneficial functional features described herein.

In an exemplary implementation, a unique graphical user interface is implemented as a means of reducing the amount of scrolling required of the user, and optimizing the use of limited space on a web page. The enhanced icon-implemented control is best used when the user does not need to visit every page, and can visit pages in any order, but may need explanatory text or advanced options only on selected pages or input panes. The disclosed system enhances a user interface control to combine some of the best features of both novice and expert user interface styles in a single control.

In standard “accordion” control schemes, each information input pane can be in one of two states. An input pane may be either fully closed, displaying only the title bar of the accordion pane, or fully open, displaying all of the text and user interface controls on the pane. In the following example, a partially open state is illustrated, i.e. one in which only one or two critical interaction elements are visible. For example, only a single text entry field with its accompanying label may be displayed. This state corresponds to the “fast path” or expert mode of the application. If the user needs additional help completing the text field or other control, he or she can click a control in the accordion pane header to open the pane fully. This would display all the additional text that typically appears on a wizard page. This partial closure technique can also be used to hide little-used or advanced options or input fields until the user chooses to view them.

Using the exemplary accordion control does not replace traditional wizard interfaces, which are best used when the user must complete a sequence of steps in order, without skipping any steps, and when a considerable amount of explanatory text may be needed. The enhanced accordion control, on the other hand, is best when the user does not need to visit every page, can visit pages in any order, and may need explanatory text or advanced options only on selected pages.

To support the software developer using the enhanced control, structures and controls would be added to the developer toolkit. These controls would divide the content of the control into sections or segments that specify which content is included in the partially open state, and which content is displayed when the control is fully open. Other options for control behavior are also included. For example, the developer can specify that for a given instance of the control, the initial display state should be fully expanded, or fully closed. Such capabilities can readily be implemented using commonly available developer toolkits.

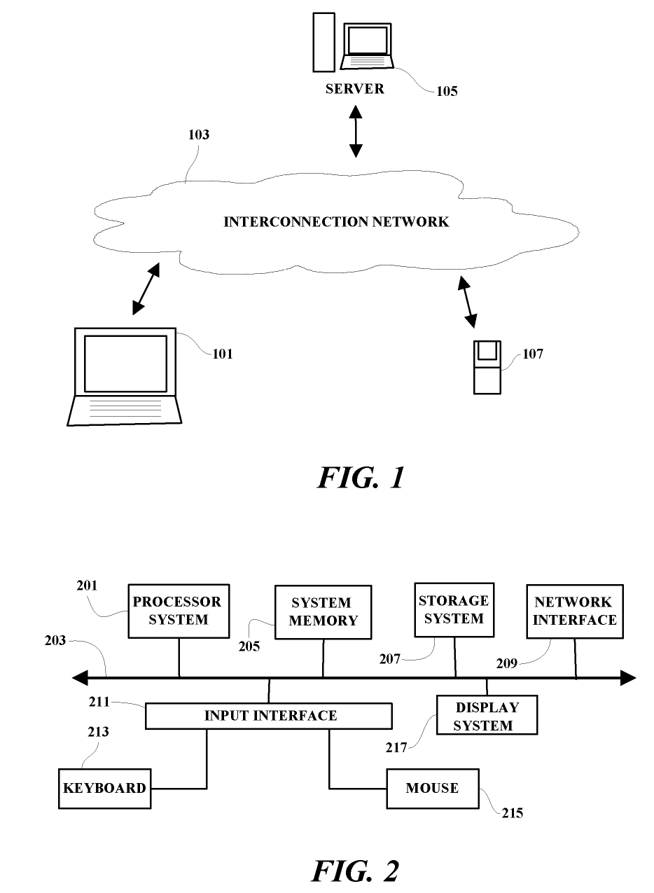

FIG. 1 illustrates an exemplary environment in which the present invention may be implemented. As shown, a user terminal 101, which may be a laptop computer, is connected through an interconnection network 103, such as the Internet, to a server 105. The server 105 may also be accessed from cell phones and other personal wireless devices such as device 107. Server 105 may be accessed by the user unit 101 to download or access one or more applications for use and/or input at the user terminal 101/107, and any information input by the user may be uploaded back to the server 105. In the example discussed below, the server 105 is operated by a hotel establishment and the user may access reservation records at the server 105 to reserve a room at a future date.

FIG. 2 illustrates several of the major components of a computer system which may be used to implement the present invention. As shown, a processor system 201 is connected to a main bus 203. The main bus 203 is also coupled to, inter alia, system memory 205, a local storage system 207, a network interface 209, an input interface 211 including connections to a keyboard 213 and a mouse or pointing device 215. The main bus is also connected to a display system 217.

In the example, a guest record at a hotel includes much information which is input and maintained at the hotel server 105. A complete display of all of the fields of the guest record would be so extensive that it would not normally be able to be displayed on a given user display device, especially if the user device is a personal digital assistant (PDA), cell phone or other small wireless device. In order to enable a user to enter the most significant data for a hotel reservation for example, the hotel record is divided into compressed sections or segments, and each section is displayed within a single information input pane and accompanying icons to actuate further functions with regard only to the particular pane in which the icons are presented.

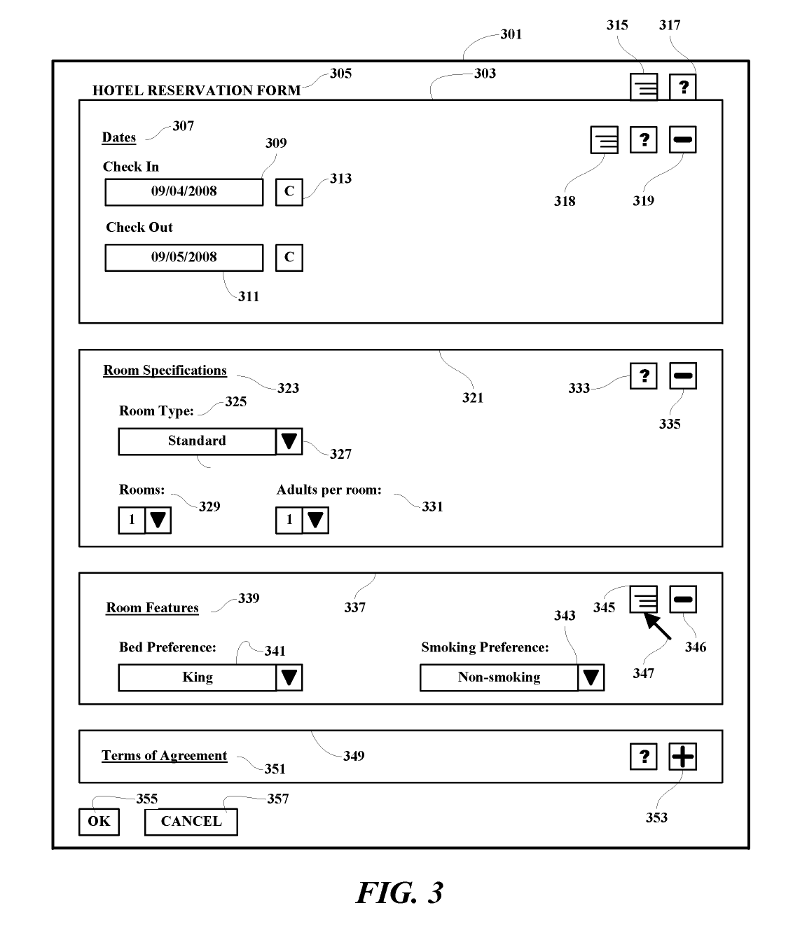

In an example, for a hotel reservation, the hotel needs dates for check-in and check out, room specifications and room features desired by the guest. In addition, the hotel needs to have the guest read and agree to the terms of a guest agreement. Thus, in the disclosed example, with reference to FIG.3, four information input panes would be initially displayed on a user display device 301 in order to solicit the necessary information for a hotel reservation 305, namely a data pane 303, a room specification pane 321, a room feature pane 337 and a terms of agreement pane 349. The four panes illustrated represent a compressed form of the full guest information record. Each of the panes may be designed to be expanded by user selection to display additional information and/or input fields. For example, icon 315 may be actuated by a user to display additional information and/or input fields. That expand or open icon in the present example is illustrated as a general horizontal heading line with horizontal sub-heading or detail lines below to indicate that additional detail is available for the hotel reservation form 305. Any icon design may be used for this purpose. Additional detail may be accessed and displayed to the user for panes 333 and 337 by actuating (point and click) icons 318 and 345, respectively. After a pane has been opened by a user, the user may then collapse the pane again by actuating an appropriate collapse icon such as icon 319 for pane 303, icon 335 for pane 321 or icon 346 for pane 337. Help icons such as icon 317 and 333 are also illustrated to provide “wizard” type of detailed assistance to the user. If such detailed assistance is not needed by a user however, the panes may remain in a closed or compressed state allowing a user to enter necessary data into the form without undue scrolling through help or instruction screens.

When inputting to the displayed hotel reservation input screen 301, a user will use a dates function 307 and enter a check-in date 309 and a check-out date 311 in the dates pane 303. The user may also select a calendar aid “C” 313 to display a calendar to facilitate the user's input. If the user needs additional information for the dates pane 303, the user may actuate the expand icon 318, and additional detail may be provided. Such detail for this section may include for example, certain dates that are blocked out because the hotel is fully booked.

In using the room specification pane 321, a user is enabled to specify a room type 325 such as “standard”, or other room type by actuating icon 327. Further, the user may input the number of rooms desired to be reserved 329 and the number of adults per room 331. Icon 333 may be actuated to display help details for this pane and icon 335 may be actuated by the user to collapse pane 321 to a more compressed version. The collapsed version may show only the room type 325 and not the number of rooms 329 or the adults per room 331.

For the room feature pane 337, a user may designate the desired room features 339. For example the user may designate a bed size preference 341 and a smoking preference 343. The icon 345 indicates that this pane 337 has additional selections available and also that the pane 337 may be collapsed to a more compressed version by actuating icon 346. The user may actuate the icon 345 by using a mouse pointer indicium 347 to point and click on the expand icon 347.

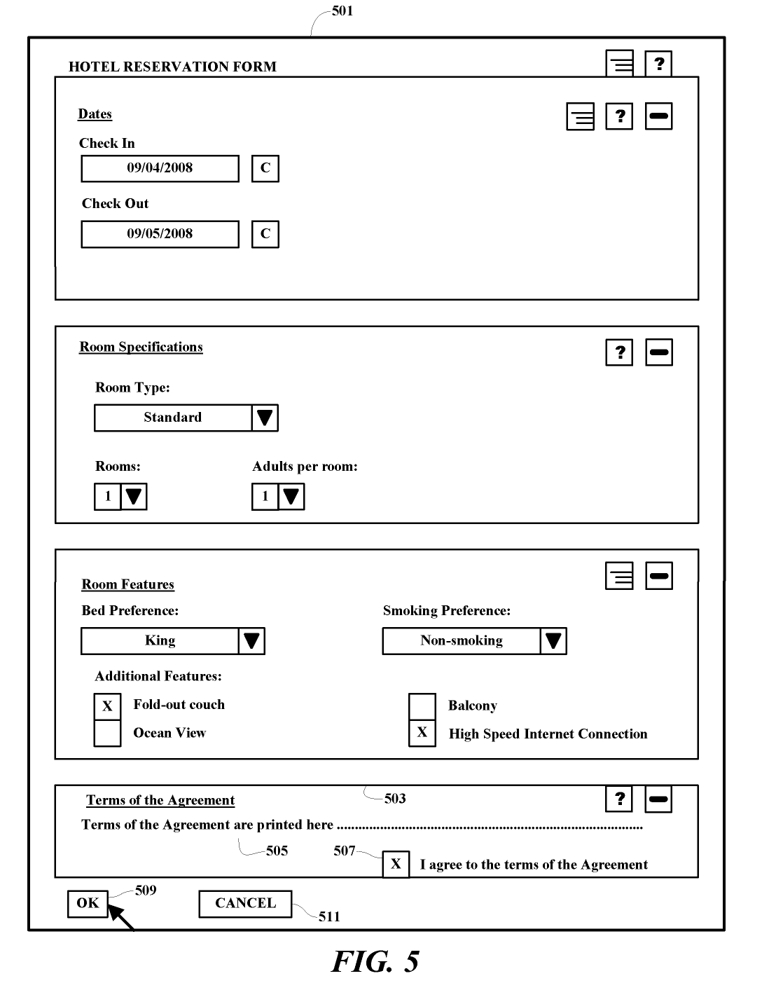

In the terms of agreement pane 349, a user is enabled to select to display the full terms of agreement 351 by actuating the icon 353. As shown in FIG. 5, the user may check a box to agree to the displayed terms of agreement and complete the reservation process. At any time the user may select “OK” button 355 to enter the information input by the user, or select the “CANCEL” button 357 to cancel the input and not enter any additional information.

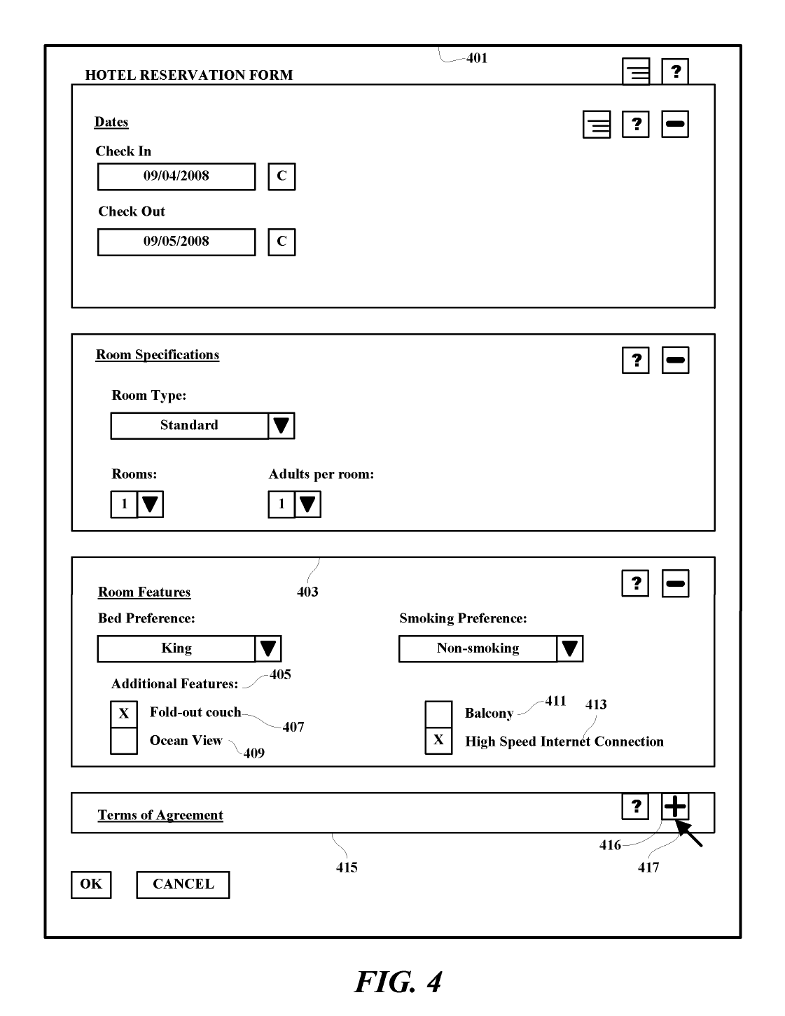

In FIG. 4, an exemplary display screen 401 illustrates the next screen that may be presented if a user selected to expand the “Room Feature” pane 337 of FIG. 3. The expanded Room Feature pane 403 may include, for example, additional selections such as a “Fold-Out Couch” 407, an “Ocean View” 409, a “Balcony” 411 and/or a “High Speed Internet Connection” 413. A user may also actuate the detail icon 416 with the mouse indicium 417 in the “Terms of Agreement” pane 415 to have the terms of the entire guest agreement displayed as illustrated in FIG. 5.

As shown in FIG. 5, when the Terms of Agreement pane 503 is displayed in detail 505, the user is enabled to accept the terms 507 and actuate the “OK” button 509 to enter all of the data input by the user. If sufficient information has not been entered by the user, an appropriate message (not shown) will be presented to prompt the user to correct or add to the record. The user may also Cancel the input by actuating the CANCEL button 511.

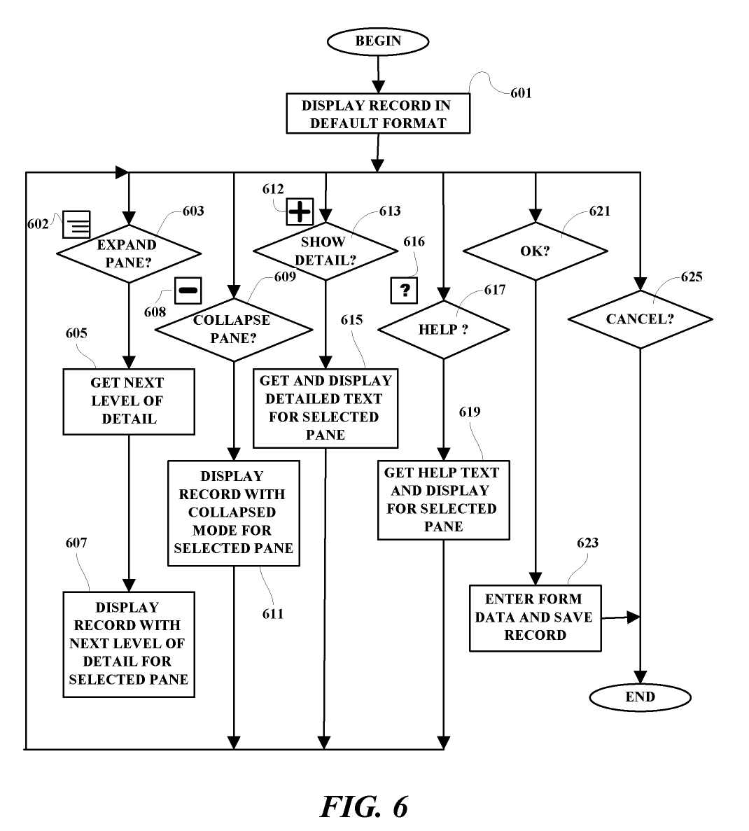

An exemplary operational flow sequence is presented in FIG. 6. As shown, after a user accesses a hotel reservation form and the form, in its compressed mode, is displayed on a user display device, the user may make any of a plurality of selections to facilitate user input. A user may actuate an expand icon 602 to expand 603 the pane in which the actuated icon is located. The expansion process gets the next level of detail 605 for the appropriate pane and displays the record with the more detailed pane 607. If the user actuates the collapse icon 608, the pane in which the actuated icon is located is collapsed 609 and the pane is presented in a compressed or collapsed mode 611 showing less detail for the appropriate pane. If the show detail icon 612 is actuated, the show detail process 613 gets and displays 615 detailed text and/or graphics for the selected pane. Similarly, if the help icon 616 is actuated, the help function 617 gets and displays appropriate help information for the pane in which the help icon is located. At any time the user may actuate the OK button 621 to enter data and save the record 623 of the user, or select the cancel button 625 to end the process.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored in any media, including any portable or fixed, volatile or non-volatile memory media device, including CDs, RAM and “Flash” memory, or other semiconductor, optical, magnetic or other memory storage media from which it may be loaded and/or transmitted into other media and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for processing user input to a record presented on a display screen of a user computer device, said method comprising:
displaying separate input portions of said record in separate areas of said display screen, each of said areas representing a separate input section of said record for receiving input from a user; and
providing means for enabling a user to make a selection to expand at least one of said separate areas to display an expanded area, said expanded area comprising a more detailed input format for receiving more detailed input from said user.

2. The method as set forth in claim 1 wherein said means for enabling said user to make a selection to expand at least one of said separate areas comprises displaying a selectable icon in said at least one of said separate areas.

3. The method as set forth in claim 2 wherein all of said separate areas of said record are presented simultaneously on said display screen of said user computer device, whereby said user is enabled to view all segments of an entire record on a single display screen at one time.

4. The method as set forth in claim 3 and further including enabling said user to select to reduce said expanded area to a smaller area on said display screen after having viewed said expanded area.

5. The method as set forth in claim 3 and further including saving user input to said record.

6. The method as set forth in claim 5 wherein said user input is saved to a memory located within said user computer device.

7. The method as set forth in claim 5 wherein said record is maintained at a server system, said method further including transmitting said user input to said server system, and saving said user input in a memory of said server system.

8. The method as set forth in claim 1 wherein said user computer device is a hand-held wireless device.

9. The method as set forth in claim 1 wherein said user computer device is a laptop computer device.

10. A programmed medium including programming information executable by a computer system for providing program signals for enabling a processing of user input to a record presented on a display screen of a user computer device, said program signals being effective for selectively accomplishing the steps of:
displaying separate input portions of said record in separate areas of said display screen, each of said areas representing a separate input section of said record for receiving input from a user; and
providing means for enabling a user to make a selection to expand at least one of said separate areas to display an expanded area, said expanded area comprising a more detailed input format for receiving more detailed input from said user.

11. The medium as set forth in claim 10 wherein said means for enabling said user to make a selection to expand at least one of said separate areas comprises displaying a selectable icon in said at least one of said separate areas.

12. The medium as set forth in claim 11 wherein all of said separate areas of said record are presented simultaneously on said display screen of said user computer device, whereby said user is enabled to view all segments of an entire record on a single display screen at one time.

13. The medium as set forth in claim 12 wherein said program signals are further effective for enabling said user to select to reduce said expanded area to a smaller area on said display screen after having viewed said expanded area.

14. The medium as set forth in claim 12 wherein said program signals are further effective for enabling said user to save user input to said record.

15. The medium as set forth in claim 14 wherein said user input is saved to a memory located within said user computer device.

16. The medium as set forth in claim 14 wherein said record is maintained at a server system, said program signals being further effective for enabling a transmitting of said user input to said server system, and enabling a saving said user input in a memory of said server system.

17. The medium as set forth in claim 10 wherein said user computer device is a hand-held wireless device.

18. The medium as set forth in claim 10 wherein said user computer device is a laptop computer device.

19. A system for processing user input to a record presented on a display screen of a user computer device, said system comprising:
means for displaying separate input portions of said record in separate areas of said display screen, each of said areas representing a separate input section of said record for receiving input from a user; and
means for enabling a user to make a selection to expand at least one of said separate areas to display an expanded area, said expanded area comprising a more detailed input format for receiving more detailed input from said user.

20. The system as set forth in claim 19 wherein said means for enabling said user to expand at least one of said separate areas comprises displaying a first icon in said at least one of said separate areas, and providing means by which said user is enabled to actuate said first icon to expand said separate area in which said first icon is displayed.
